(19) United States
(12) Patent Application Publication
(10) Pub. No.: US 2016/0204413 A1
(43) Pub. Date: Jul. 14, 2016

(54) METHOD AND COMPOSITION FOR PRODUCING POSITIVE ELECTRODES FOR LITHIUM ION BATTERIES

(71) Applicant: VW-VM FORSCHUNGSGESELLSCHAFT MBH & Co. KG, Ellwangen Jagst (DE)

(72) Inventors: Markus Pompetzki, Aalen (DE); Konrad Holl, Aalen (DE); Jürgen Moß, Waldenburg (DE); Sebastian Schebesta, Ellwangen (DE)

(21) Appl. No.: 14/911,785

(22) PCT Filed: Feb. 20, 2014
(86) PCT No.: PCT/EP2014/053310

§ 371 Date: Feb. 12, 2016

(30) Foreign Application Priority Data
Aug. 13, 2013 (DE) 10 2013 216 046.1

(51) Int. Cl. H01M 4/04; H01M 4/62; H01M 4/1391; H01M 4/58; H01M 4/485; H01M 10/0525; H01M 4/66

(52) U.S. Cl. CPC H01M 4/0404; H01M 10/0525; H01M 4/621; H01M 4/62; H01M 4/661; H01M 4/5825; H01M 4/485; H01M 4/1391; H01M 4/662; H01M 4/622; H01M 2004/028

(57) ABSTRACT

A process of producing positive electrodes for lithium ion batteries including providing a composition containing at least one active material that takes up and releases lithium ions during charging and discharging of a lithium ion battery, at least one electrode binder, at least one conductivity improver and water as a solvent and/or suspension medium; providing a current collector having a surface composed of aluminium or of an aluminium alloy; and applying the composition to the surface of the current collector, wherein the composition is alcalinically modified by addition of at least one base so that the pH of the composition is increased before it is applied to the surface of the current collector.

### TECHNICAL FIELD

This disclosure relates to a process and a composition for producing positive electrodes for lithium ion batteries.

### BACKGROUND

The term “battery” originally meant a plurality of electrochemical cells connected in series. However, a single electrochemical cell is nowadays also frequently referred to as a battery. When an electrochemical cell is discharged, an energy-supplying chemical reaction made of two subreactions electrically coupled with one another but spatially separated from one another takes place. At the negative electrode, electrons are liberated in an oxidation process, resulting in an electron current (generally via a load) to the positive electrode by which a corresponding quantity of electrons is taken up. A reduction process thus takes place at the positive electrode. At the same time, an ion current corresponding to the electrode reaction flows within the cell. This ion current is ensured by an ion-conducting electrolyte. In secondary cells and batteries, this discharging reaction is reversible and there is thus the opportunity to reverse the conversion of chemical energy into electric energy which occurred on discharging.

Comparatively high energy densities are achieved among known secondary cells and batteries, in particular by lithium ion batteries. Many lithium ion batteries contain a cell stack (stack) consisting of a plurality of single cells. Rolled cells (jelly rolls) are frequently also used. The cells in a lithium ion battery are usually an assembly of electrodes and separators having the sequence “positive electrode/separator/negative electrode.” Such single cells are sometimes also produced as bicells having the possible sequences “negative electrode/separator/positive electrode/separator/negative electrode” or “positive electrode/separator/negative electrode/separator/positive electrode.” Such electrodes usually comprise metallic current collectors normally present in the form of foils or sheet-like structures. In a positive electrode, this is usually a mesh or foil composed of aluminum, for example, expanded aluminum metal or an aluminum foil. On the side of the negative electrode, meshes or foils composed of copper are mostly used as collectors.

In general, the above-described cells for lithium ion batteries are produced in a multi-stage process. The electrodes are usually produced in a first step and subsequently combined with one or more separators to form the electrode-separator assemblies mentioned. Electrodes and separators can be loosely stacked or rolled or else joined to one another in a lamination step.

To produce the electrodes, thin electrode films are formed, for example, by a doctor blade or a slot die, on the current collectors from usually paste-like compositions comprising a suitable electrochemically active material (“active material”). Active materials suitable for the electrodes of a lithium ion battery have to take up and again release lithium ions which, during charging and discharging, migrate from the negative electrode to the positive electrode (and vice versa). An active material suitable for negative electrodes of lithium ion batteries is, for example, graphite. Active materials suitable for positive electrodes are, in particular, lithium cobalt oxide (LCO) having the empirical formula LiCoO₂, lithium nickel manganese cobalt oxide (NMC) having the empirical formula LiNiₓMn_{y}Co_{z}O₂, lithium manganese spinel (LMO) having the empirical formula LiMn₂O₄, lithium iron phosphate (LFP) having the empirical formula LiFePO₄ or lithium nickel cobalt aluminum oxide having the empirical formula LiNiₓCo_{y}Al_{z}O₂ (NCA). Mixtures of the materials mentioned can also be used.

Apart from the active materials, the compositions generally additionally contain an electrode binder (“binder”), a conductivity improver, a solvent or suspension medium and optionally further additives, for example, to influence their processing properties. An electrode binder forms a matrix in which the active material and optionally the conductivity improver can be embedded. The matrix should ensure an increased structural stability during volume expansions and contractions caused by lithiation and delithiation. Possible solvents or suspension media are, for example, water or organic solvents such as N-methyl-2-pyrrolidone (NMP) or N-ethyl-2-pyrrolidone (NEP). An example of a binder that can be processed in aqueous medium is sodium carboxymethyl cellulose (Na-CMC). An example of a binder that can be processed in organic solvents is polyvinylidene difluoride (PVDF). As additives, it is possible to add, for example, rheological auxiliaries. The conductivity improver is usually an electrically conductive carbon-based material, in particular conductive carbon black, conductive graphite, carbon fibers or carbon tubes.

Solvent or suspension medium present in the compositions is generally removed during application to the current collector or immediately afterwards by evaporation. This evaporation process results in formation of a solid electrode film that adheres to the respective current collector. The electrode films formed are densified, for example, in a calendering process. The electrodes can then be assembled to form the cells mentioned at the outset.

However, adhesion of the electrode to the current collector is frequently unsatisfactory, especially on the side of the positive electrode. When current collectors composed of aluminum are stored in ambient air, a surface oxide layer is virtually unavoidably formed on the collectors, and this can have an adverse effect on adhesion of the electrode film. In addition, aluminum oxide does not have good electrical conductivity so that the transition resistance at the interface between the electrode and the current collector is increased by the oxide layer. If such a cathode is installed in a cell, the cell generally has a higher cell impedance. During the cycling life, this leads to increased internal cell temperatures and thus to a shortening of their life.

To overcome this problem, the current collectors composed of aluminum can be pickled in a separate, additional process step. A procedure of this type is described in DE 19807192 B4. However, this incurs additional costs due to the additional preceding step and the aluminum surface obtained has to be protected against reoxidation if the application of the electrode film does not follow immediately.

As an alternative, the surface of aluminum collectors can be covered with a thin graphite layer to suppress growth of an oxide layer in ambient air. However, that procedure is also laborious and expensive.

### SUMMARY

We provide a process of producing positive electrodes for lithium ion batteries including providing a composition containing at least one active material that takes up and releases lithium ions during charging and discharging of a lithium ion battery, at least one electrode binder, at least one conductivity improver and water as a solvent and/or suspension medium; providing a current collector having a surface composed of aluminum or of an aluminum alloy; and applying the composition to the surface of the current collector, wherein the composition is alcalinically modified by addition of at least one base so that the pH of the composition is increased before it is applied to the surface of the current collector.

We also provide a process of producing positive electrodes for lithium ion batteries including providing a composition containing at least one active material that takes up and releases lithium ions during charging and discharging of a lithium ion battery, at least one electrode binder, at least one conductivity improver and water as a solvent and/or suspension medium, providing a current collector having a surface composed of aluminum or of an aluminum alloy, and applying the composition to the surface of the current collector, wherein the composition is alcalinically modified by addition of at least one base so that the pH of the composition is increased to a value of greater than 8.5 before it is applied to the surface of the current collector.

### DETAILED DESCRIPTION

Our process produces positive electrodes for lithium ion batteries. As stated at the outset, the known forming process comprises the following steps:
(1) providing a composition containing an active material, an electrode binder, a conductivity improver and water as solvent and/or suspension medium,
(2) providing a current collector having a surface composed of aluminum or of an aluminum alloy, and
(3) applying the composition to the surface of the current collector.

Our process is distinguished from the known process above in that the composition has been alcalinically modified by addition of at least one base. The term “alcalinically modified” means that the composition is modified by addition of the base so that its pH is increased before the composition is applied to the surface of the current collector. In particular, the base is a compound containing hydroxide ions, in particular an alkaline earth metal hydroxide or alkali metal hydroxide.

When this composition that has been alcalinically modified is used, the current collector, which can be, for example, an aluminum foil and the surface of which may have an oxide layer, is pickled in situ during the application step (3). This produces improved cycling stabilities and impedance values in the cell.

The pH of the composition is preferably a value of >8.5, in particular a pH of >9. Particular preference is given to a pH of 8.5 to 12, in particular 9 to 11. This ensures that the pickling process occurs with satisfactory efficiency according to the following equation:

Al₂O₃+3H₂O+2OH⁻->2[Al(OH)₄]⁻.

The at least one base is particularly preferably lithium hydroxide or ammonium hydroxide. When such bases are used, volatile pickling products are generally formed, which shifts the chemical equilibrium of the pickling process in an advantageous way:

LiOH: 2Al+6H₂O+2LiOH->2Li⁺+2[Al(OH)₄]⁻+3H₂

NH₄OH: 2Al+6NH₄OH+->2Al(OH)₃+3H₂+6NH₃.

The electrode binder is preferably a cellulose-based binder, an acrylate-based binder, a polyolefin-based binder or a mixture thereof. The cellulose-based binder is preferably sodium carboxymethyl cellulose (Na-CMC), the acrylate-based binder is preferably a polyacrylate which can be processed in water. Preferred polyolefin-based binders are, for example, aqueous suspensions of finely divided polyethylene particles. It is also possible for two or more different electrode binders to be present in the composition.

Conductivity improvers suitable for the electrodes of lithium ion batteries have been mentioned at the outset. These can also be used. The composition optionally also contains one or more additives. It is also possible for two or more different conductivity improvers to be present in the composition.

The active material present in the composition is preferably at least one member of the group consisting of LCO, NMC, LMO, LFP and NCA. It is also possible for two or more different active materials to be present in the composition.

The components described are preferably present in the following proportions in the composition:
from 30 to 70% by weight of water,
from 30 to 60% by weight of the active material,
from 0.1 to 10% by weight of the conductivity improver,
from 0.1 to 10% by weight of the binder, and
from 0 to 5% by weight of the compound containing hydroxide ions.
   The respective proportions in the composition add up to 100% by weight.

In positive electrodes that have been produced by our process, there are generally traces of a basic additive, in particular a compound containing hydroxide ions, e.g., lithium hydroxide or ammonium hydroxide. Such electrodes, too, are encompassed by our process regardless of whether they are present separately or are installed in a lithium ion battery. Such a lithium ion battery is naturally also provided.

Further advantages and aspects can be derived not only from the appended claims, but also from the following description of a preferred working example.

### Working Example

A composition that can preferably be used contains the following components in the following proportions:
50.7% by weight of water as solvent or suspension medium
43.7% by weight of LFP (lithium iron phosphate) as active material
2.4% by weight of conductive carbon as conductivity improver
1.5% by weight of a polyacrylate binder
1.0% by weight of LiOH as basic additive
0.7% by weight of Na-CMC, here as additive for setting the viscosity.

To provide the composition, the water was placed in a vessel and the Na-CMC to increase the viscosity was subsequently added and dissolved by stirring. This was followed by adding the conductivity improver and then the active material. The formed suspension was homogenized by stirring. The polyacrylate binder and the basic additive were finally added.

The formed suspension was applied by a doctor blade to an aluminum foil (as current collector) to form an electrode film. After the doctor blade coating process, the electrode film was dried and subsequently densified. The electrode formed was installed in a test cell and compared to a reference electrode that had been produced in an identical way but without the basic additive. The cell having our electrode displayed an improved cycling stability and better impedance values.

1-7. (canceled)

8. A process of producing positive electrodes for lithium ion batteries comprising:
providing a composition containing at least one active material that takes up and releases lithium ions during charging and discharging of a lithium ion battery, at least one electrode binder, at least one conductivity improver and water as a solvent and/or suspension medium;
providing a current collector having a surface composed of aluminum or of an aluminum alloy; and
applying the composition to the surface of the current collector,
wherein the composition is alcalinically modified by addition of at least one base so that the pH of the composition is increased before it is applied to the surface of the current collector.

9. The process as claimed in claim 8, wherein the composition has a pH of greater than 8.5.

10. The process as claimed in claim 8, wherein the at least one base is a compound containing hydroxide ions, lithium hydroxide or ammonium hydroxide.

11. The process as claimed in claim 8, wherein the electrode binder is a cellulose-based binder, an acrylate-based binder, a polyolefin-based binder or a mixture thereof.

12. The process as claimed in claim 8, wherein the active material is at least one member selected from the group consisting of LCO, NMC, LMO, LFP and NCA.

13. A process of producing positive electrodes for lithium ion batteries comprising:
providing a composition containing at least one active material that takes up and releases lithium ions during charging and discharging of a lithium ion battery, at least one electrode binder, at least one conductivity improver and water as a solvent and/or suspension medium;
providing a current collector having a surface composed of aluminum or of an aluminum alloy; and
applying the composition to the surface of the current collector,
wherein the composition is alcalinically modified by addition of at least one base so that the pH of the composition is increased to a value of greater than 8.5 before it is applied to the surface of the current collector.
